(19) United States
(12) Patent Application Publication
(10) Pub. No.: US 2019/0042987 A1
(43) Pub. Date: Feb. 7, 2019

(54) LIFE CYCLE MANAGEMENT SYSTEM FOR PLANT COMPONENTS

(71) Applicant: FESTO AG & Co. KG, Esslingen (DE)

(72) Inventors: Thomas Heubach, Weinstadt (DE); Frank Benkart, Uhingen (DE); Sven Haugstetter, Leonberg (DE); Matthias Dreher, Kirchheim-Nabern (DE); Michael Hoffmeister, Esslingen (DE); Jan Bredau, Kernen i. R. (DE); Wolfgang Engler, Plochingen (DE); Martin Fuss, Uhingen (DE); Herbert Hufnagel, Aichwald (DE); Norbert Machau, Göppingen (DE)

(21) Appl. No.: 16/159,262

(22) Filed: Oct. 12, 2018

Related U.S. Application Data
(63) Continuation of application No. PCT/EP2017/058531, filed on Apr. 10, 2017.

(30) Foreign Application Priority Data
Apr. 22, 2016 (DE) 10 2016 107 560.4

(51) Int. Cl. G06Q 10/06; G06F 17/30; G05B 19/418

(52) U.S. Cl. CPC G06Q 10/06; G06F 17/30557; G06F 17/30289; G06F 17/30312; G05B 19/4185

(57) ABSTRACT

In a system and a method for the automated design of an automation unit, multiple electronically controllable components are interconnected in a work dependency. The system includes a central web server having a database, an interface for importing technical application data for the automation unit, a processor, which applies technical application data and provided functionality data sets of the components according to interconnection rules to generate a circuit diagram for the components. The system can also include a converting unit, which converts the generated circuit diagram into control commands for the design of the automation unit.

### CROSS REFERENCE TO RELATED APPLICATIONS

This application is a continuation application of international patent application PCT/EP2017/058531, filed Apr. 10, 2017, which claims priority to German patent application DE 10 2016 107 560.4, filed on Apr. 22, 2016, both of which are hereby incorporated by reference in their entireties.

### TECHNICAL FIELD

The disclosure relates to the area of automation and specifically relates to a system, a method, and a product for the automated assembly and for operating an automation unit in which multiple electronically controllable components, such as pneumatic cylinders, valve locations, and sensors, are interconnected in a work dependency.

### BACKGROUND

In the systems known today, the whole life cycle of a unit with its components is supported only insufficiently. It is known to hold data available for the individual components in a component-manufacturer-specific database. If the components are implemented in the unit, that information is no longer available on a regular basis or centrally.

It is important for the design and for the operation of the automation unit to provide information across components, meaning especially information on the interconnection of the individual components within the automation unit (so called object dependencies or inter-component knowledge). These data sets across components concern, e.g., data on where the respective component is implemented, with which neighboring components it is in a data exchange, which interfaces it comprises, which input data and/or which control data it requires etc.

There are maintenance systems known in the related art wherein a maintenance schedule is developed for one or several field device(s). Thus, U.S. Pat. No. 8,260,759 B2 describes a method for the maintenance of a manufacturing installation, which works with two separate databases: a manufacturer database and a customer database.

DE 10 2007 039 531 shows a method for obtaining maintenance-relevant information on an automation unit. A knowledge system is used in which maintenance-relevant information on the unit and on the field devices are stored.

In the related art, automation units are already planned, designed, and put into operation and are meant to be serviced or maintained during the operation phase. For that, the systems described above can be accessed.

Furthermore, life cycle management systems are known with which a product can be administered throughout its life span. Such a system is described in U.S. Pat. No. 8,443,355 B2. There, the system serves for the location-independent operation of multiple devices within a process plant and the monitoring of the same during the operation of the unit for the execution of a life cycle management.

### SUMMARY

It is an object of the present disclosure to provide a system with which an automation unit provides pre-selected and relevant component information throughout the entire life span of the unit from the design and planning (thus, before the launch) until the operation and the lifetime end of the unit, which also comprise the interaction of the components among themselves, to enable further processing with regards to the automation unit.

This object is achieved according to the disclosure with a system and a method for the automated configuration of an automation unit.

In the following, the disclosure is described by means of the solution of the object according to the device and thus by means of the system. Features, advantages, or alternative embodiments mentioned therein are to be transferred as well to the other claimed subject-matters and vice versa. In other words, the method can be further developed with the features that are described or claimed in connection to the system. The respective functional features of the method are provided by respective structural modules, especially by electronic circuit components or microprocessor modules of the system and vice versa.

According to one aspect, the disclosure relates to a system for the automated design of an automation unit in which multiple electronically controllable components are to be interconnected in a work dependency, with:

A central web server which interacts with a database,
a) in which a digital copy with a functionality data set is provided for each component and
b) in which interconnection rules for the interconnection of the components are provided;
   an interface for importing technical application data for the automation unit;
a processor that is configured to allocate the technical application data and the provided functionality data sets of the components by means of the interconnection rules in order to generate a circuit diagram for the components; and
a converting unit that is adapted to convert the generated circuit diagram into control commands for the design of the automation unit.

In an exemplary embodiment of the disclosure, the system itself can be designed as a web server which is in data exchange with the database and that comprises an interface, a processor and a converting unit. In another exemplary embodiment of the disclosure, the system can also be designed without the converting unit and can only comprise the interface and the processor.

The term “design” relates to the technical planning and construction of the automation unit. There, several separate components can be interconnected according to a specific circuit diagram that is dependent on the respective application of the automation unit. The design can also relate to a later period, thus an operating phase of the automation unit and/or a disassembly phase in which the automation unit is disassembled and delivered to recycling.

The automation unit can also be an electronically controlled unit for different operation purposes with multiple physical or technical components, e.g., a manufacturing installation or a production line or a unit or a network of units.

The components are technical elements or field devices that can be controlled electronically. The components can possess component elements of different kinds, e.g., analog components (valves, switches, etc.) and digital components (e.g., software-based control units etc.). The components are interconnected according to the functionality of the respective component and the whole unit according to a circuit diagram to build a work dependency. This way, for example, a chain of effects from several, successively interconnected components can be developed. More complex structures (comprising cyclic or reticular component-structures) can be developed as well. According to the disclosure, each component is assigned a logical representation of the respective component which functions as a virtual or digital copy of the real physical component. A digital data set exists for the logical representation. The physical or technical components are in data exchange with each other via a digital network, e.g., a fieldbus system, and in data exchange with a central web server.

The interconnection rules define how the individual components can be interconnected in order to conform to a superordinate functionality within the scope of the automation unit. Thus, it can be regulated in the interconnection rules which added elements of the respective components have to be installed upstream and which secondary components have to follow them in the circuit, for example. It can also be specified which additional components necessarily have to be connected to a component (e.g., it can be defined that a pneumatic cylinder always has to be developed with a sensor system, e.g., a position indicator switch, to be able to regulate and control the position of the cylinder). The interconnection rules can be generated during the development of a new product. To do that, data can be read out from a memory or a database or an external database to specify e.g., the pneumatic and/or electric dimension (flow rate, force, power supply, performance, areas of application . . . ) as well as electric and/or mechanic interfaces (fieldbus protocols, companion dimensions, circuit diagrams for attaching, etc.). The interconnection rules can be stored in tables or in semantic networks and can be consulted during the setup of interconnection chains from individual components for checking the compatibility. Additionally, all components are assigned to a category (control, communication . . . ), so that an easy setup of an interconnection chain or a more complex interconnection pattern of physical components is possible. A first application of the interconnection rules can take place in a design- and configuration-tool. There, the whole or a partial interconnection chain is set up and uploaded into the system including the interconnection rules. If the setup of the interconnection chain results from the system according to the disclosure from individual components, the compatibility check takes place during the saving of the interconnection chain. If the compatibility check is negative, a compatible interconnection chain that is aligned with the application data is suggested automatically.

The functionality data set can relate to a single component and can determine which function the component observes and in an exemplary embodiment of the disclosure, the functionality data set additionally defines the functional dependencies between the individual components. Thus, it can be calculated from the functionality data set which component has to be interconnected with which other component(s) to fulfill a certain application and function. Furthermore, metadata can be defined for the functionality of the component, meaning e.g., when the functionality is to be provided, on which conditions etc.

The application data define the technical envisioned use of the automation unit and can e.g., indicate for which automation object the automation unit is meant to be designed. For this purpose, the application data can, e.g., comprise TARGET-parameters. The TARGET-parameters can relate, e.g., to concrete technical application parameters, such as the travelling distance of a cylinder or can comprise time-related parameters, such as, cycle times. The TARGET-parameters can define forces, such as, TARGET- or maximum forces. Furthermore, threshold values and/or precision requirements, e.g., for the accuracy that has to be adhered to, can be specified. The TARGET-parameters can be defined for a specific component, e.g., for a piston-cylinder system or can be defined on a more general specification level for the movement task in general, which can generally be carried out pneumatically or electrically as well. In principle, the application data can be imported from a simulation tool and/or a CAD model. The application data can also comprise test data and traceability data. Traceability data enable the analysis of how the respective component has been built into the unit throughout the life span of the same and in which versions it has been interconnected. Equally, the traceability data can enable an analysis of which modifications have already been carried out on the product already in use or on certain elements or components of the automation unit. This way, the component manufacturer can gather information about which components have been modified in an admissible or inadmissible way by the unit operator or unit manufacturer, for example. In the case of objections, the cause for an identified error can be found advantageously very easily and efficiently. Equally, modifications can be checked regarding their admissibility and this check can also be retraced so that data on an already dated back period of time are accessible. This way it can be checked automatically if the components and/or elements of the system have been used according to the regulations or not. Overall, the state of the system with its components can be monitored like that and the monitoring information is provided centrally accessible.

The processor is a computation unit for the processing of digital signals which can be developed as a microprocessor or as a computer unit.

The converting unit can be developed as a computer program or as a computer function.

The converting unit can also be integrated into the processor. The converting unit serves to generate control commands. The control commands can trigger concrete actions in the system, e.g., a modification of the system operation regarding time and/or the used components.

The circuit diagram relates to the interconnection of the individual components for providing a technical functionality of the automation unit. It can determine which component is to be connected with which other component(s). The circuit diagram can also apply to the signal and/or data exchange and the required interfaces and lines between the components (e.g., air supply and air discharge ducts, other pneumatic supply lines, electric lines, data lines, etc.). The circuit diagram can be provided in a digital version. The control commands can serve as input data sets for a computer-aided design (CAD) model, a planning tool and/or a simulation tool (e.g., on the basis of a MATLAB®/Simulink®-platform).

In a typical embodiment of the disclosure, the system according to the disclosure can also be used during the operating phase of the automation unit to regulate and/or control the operation of the system. It can be projected that state data of the respective components are to be collected locally at the component and are to be aggregated centrally and are to be provided in the central database. The state data comprise operating data which are collected locally at the respective component in a built-in state of the component in the automation unit. The state data can comprise sensor data (of position measuring sensors, pressure sensors, temperature sensors, final position switches, etc.) and other signal types (e.g., for other physical signals). Equally, digital data sets can be represented in the state data (e.g., a flag that signals if the component is active or deactivated in a certain period). Those state data can be collected for all components and can be accessible centrally via the web server. This has the important advantage that a component manufacturer, a unit manufacturer, and/or a unit operator is/are always informed on the entirety of all components used in the automation unit. An important advantage is to be seen in the fact that generally all components, also of different manufacturers, can be considered. Like that, a first component manufacturer can get access, upon fulfilling authentication requirements, to the state data of the components used in the automation unit that come from a second (foreign) manufacturer. Typically, this is enabled by requiring only a single access to the web server with the central database.

Typically, the functionality of the component and its integration in the automation unit with regards to the neighboring components can be read out or deducted from the state data. This has the advantage that in the case of an error of a component, this error state is automatically collected centrally, and it can be detected automatically, which replacement component observes the functionality requirements. For this purpose, an error log file is provided advantageously, in which the component error is provided. From this file, a computation unit can execute statistic procedures and can perform a pattern matching and set analogies off against other error situations or components to enhance the error detection over time, for example. It is also possible to develop the error detection as a self-learning system with which collected error situations and remedial actions are fed again to the system.

In a downstream procedural step, a suggestion can be calculated automatically for the interconnection of a replacement component. At a confirmation signal of the user, a virtual shopping basket of an e-commerce system is filled automatically with the correctly selected component.

In an exemplary embodiment of the disclosure, it is configurable which state data is collected and in which form. It can be adjusted, for example, that the state data are only collected from selected important components or—so as to not overload the transmission capacity between components and web server—the state data are only collected within pre-definable time intervals and/or on an event base. Furthermore, the locally collected state data can be pooled first in a temporary storage and can then be transferred as a package collectively to the web server. It is also configurable which state data are collected. Here, e.g., certain sensor data can be selected. Similarly, it is adjustable in which period of time the state data collection is to be carried out. Typically, it is preset that the state data are collected throughout the entire life span of the component and/or the automation unit. For collecting and/or forwarding the state data, all or selected components are developed with an output interface that serves to forward the collected state data, typically directly to the web server or alternatively first to a temporary storage or another processing entity.

In the database there can be provided metadata for all or selected components that are occasionally applied during the generation of the circuit diagram. The meta data can comprise already established or potential compatibility issues with other components or with certain software versions. Operation requests (e.g., typical operation time) can also be provided. Likewise, application data can be provided in the meta data. Also, the meta data can comprise test data and traceability data. Furthermore, threshold values can be comprised in the meta data and/or specifications regarding travelling distance, temperature, maximum admissible number of cycles, maintenance intervals for a preventative replacement of a component, service life, or regarding a manufacturing date of a component, etc.

In an exemplary embodiment of the disclosure, all or selected components are developed in an input interface to receive control data from the web server. The control data serve to control or regulate the respective component. They can be provided as an update, a software-patch or a new software version for component elements that are controlled software based, for example. Equally, the control data can control or regulate analog components, such as, valve units, preselector stages, boosters. etc.

A fundamental advantage of the system according to the disclosure is to be seen in that the web server is accessible centrally via a network access from different entities. This access can be controlled, e.g., by an authentication measure. For this purpose, the system is developed as a client server system. This way, it becomes possible that the component manufacturer, the unit manufacturer, and the unit operator can access consistently the same database that is provided in the database of the web server, to provide relevant data throughout the entire life span of the component (from the design and planning stages until the operation of the unit with the built-in component). For this purpose, the digital copy, the interconnection rules, the application data, the functionality data sets, the state data, and the circuit diagram are saved centrally accessible on a web server.

So as not to put the safety of the system at risk, a direct access to the components of the unit can only be activated after a successful check of a security check measure. This has the background that an alteration on the automation unit (e.g., via one of the built-in components) has to lie within the decision-making authority of the unit operator. It can thus be preset that each access on the unit has to be confirmed first with a verification signal from the unit operator.

According to another aspect, the disclosure refers to a method for the automated design of an automation unit in which multiple electronically controllable components are to be interconnected in a work dependency with the following procedural steps:

providing a digital copy with a functionality data set for each of the components on a central web server;

providing interconnection rules for interconnecting the components;

importing technical application data for the automation unit;

applying the technical application data and the functionality data sets of the components according to the interconnection rules of a processor to generate a circuit diagram for the components; and

converting the generated circuit diagram into control commands for designing the automation unit.

The method is typically used during the operation of the automation unit for controlling the same. The components can receive control data in a built-in state during the operation of the automation unit, whereby the control data are controlling the respective component in a modified way. It can also be adjusted that state data of all or selected components are collected and stored in a central database.

The method can on the one hand be used for designing the automation unit to install or construct the automation unit from the respective to be interconnected components. On the other hand, the method can be used during the operation to control or regulate the automation unit. For this purpose, the components comprise an input interface or an output interface. The output interface serves to forward state data collected locally on the component during the operation to the web server for processing and storing it there. The input interface serves to receive control data from the web server which serve to control or regulate the components (e.g., activating or deactivating them or operating them with different operation parameters). In an exemplary embodiment of the disclosure, the state data are collected while simultaneously the control data for controlling the component are provided.

The method serves for operating a web server in the context of an automation unit. The web server can be used for designing and operating the automation unit.

According to another aspect of the disclosure, a computer program product is provided that is loaded into or loadable into the non-transitory memory of a computer, a web server or an electronic device with a computer program for carrying out the method described in greater detail when the computer program is executed on the computer or on the electronic device.

According to yet another aspect of the disclosure, a computer program is provided for carrying out all procedural steps of the method described in greater detail above when the computer program is carried out on a computer or an electronic device. It is also possible that the computer program is stored on a non-transitory storage medium readable by the computer of the electronic device.

### BRIEF DESCRIPTION OF THE DRAWINGS

The disclosure will now be described with reference to the drawings wherein:

FIG. 1 shows in a schematic representation a system with a web server and a central database for controlling a launch phase of an automation unit;

FIG. 2 is a schematic representation of a data exchange between a component of the automation unit and the web server; and

FIG. 3 shows a flow chart according to an exemplary embodiment of a system for controlling an automation unit.

### DESCRIPTION OF EXEMPLARY EMBODIMENTS

In the following, the disclosure is described in greater detail in connection with the drawings.

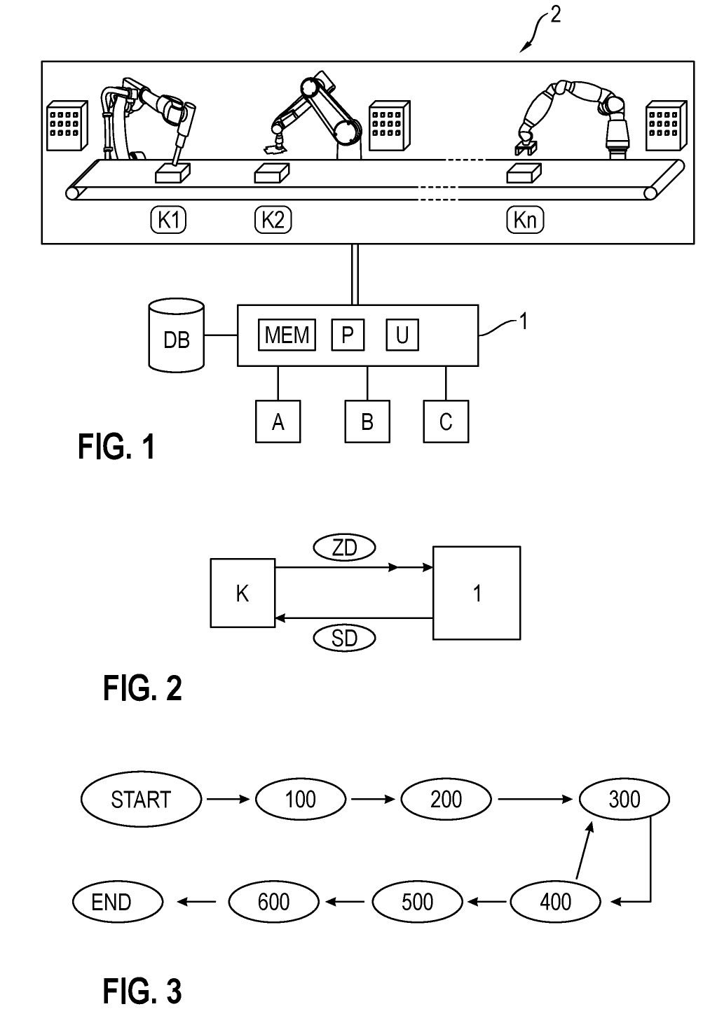

The disclosure relates to controlling a launch phase of an automation unit 2. This is described in greater detail with reference to FIG. 1. The automation unit can be a production unit with different electronically controllable components K. The components K comprise e.g., mechanical components K, such as conductors K1, running slides K2 for moving elements, leads K3 for electrically connecting elements, pneumatic components, such as pneumatic valve units K4, pneumatic power terminals K5, and electromechanical components, such as a control programmable from memory or other (e.g., software based) components K in the factory or process automation that are themselves constructed from different modules or elements, which can be built as more complex field devices. The components K have different functionalities or tasks, which they have to execute in their built-in state in the automation unit. The components K are thus built in on the basis of a work dependency. Thus, to describe it in a simplified way, the chain of effects K1->K2-> . . . Kn can be generated. It is also within the scope of the disclosure to implement more complex work dependencies.

According to an aspect of the disclosure, it is intended that for each component K, or at least a selection of relevant components K, a visualization in the form of a digital copy is generated. The digital copy can be described as a digital data set which describes the functionality of the respective component K. According to an exemplary embodiment of the disclosure, the digital data set can possess meta data on the component for the copy of the component, such as, operation requirements, durability, etc.

To control a launch process, it is determined which components K are to be used and how they are to be interconnected in the automation unit 2. For this purpose, there are interconnection rules provided in a central database DB which define which components can be interconnected in which way and with which other component(s). Furthermore, the interconnection of the components K is dependent on the respective usage. Thus, application data are imported via an interface of the web server 1. The application data can be engineering requirements (of physical nature, such as, defining a temperature range, a required pressure application, time-based parameters, etc.), designing or providing a profile of requirements and test data and/or monitoring data. Here, especially TARGET-parameters can be defined.

A processor P serves as a computation unit for generating a circuit diagram for the components K. For this purpose, the processor P applies the application data to provide functionality data sets of the components K according to interconnection rules that have been defined in a preparation phase or can be imported.

Subsequently or at a later point in time, which can be defined by the user, the generated circuit diagram is converted into control commands. The control commands determine which components K have to be used for operating the automation unit 2 and how they have to be interconnected. That creates the advantage that, in a manner of speaking, an automation unit 2 can be constructed at the push of a button.

The web server-based system according to the disclosure can, however, not only be used to control a launch of the automation unit 2, but also to monitor the operation of the automation unit 2.

For this purpose, it is typically envisioned that the components K are developed with an input interface IN or an output interface OUT. The input interface IN imports control data SD generated centrally on the web server 1 to control the component during the operation of the automation unit 2. The output interface OUT serves for the output of state data ZD that are collected locally on the component K during the operation and that are forwarded to the web server for processing. In another embodiment of the disclosure, both of the precedingly described alternatives can be executed cumulatively, so that the respective component K collects control data SD and generates and forwards state data ZD. It is also possible to develop a first selection of components K with only an input interface IN (without output interface OUT) and develop a second (different) selection of components K with only an output interface OUT (without input interface IN). That creates the advantage that the system can be adapted fundamentally more flexibly to the application without having to develop redundant resources.

FIG. 2 shows an exemplary embodiment depicting the possible data exchange between one of the components K and the central web server 1. Typically, time-dependent or event-based state data ZD are collected locally on the component K and are forwarded to the web server 1. Control data SD are generated on the central web server 1 and are transferred to the component K for the purpose of controlling it. For this purpose, a http- or http/s-based protocol or another request-response-based protocol can be used. It is also possible that the data exchange is not executed directly (as shown schematically in FIG. 2), but indirectly mediated by further instances, for example, by using a http protocol for sending the control and/or state date between a hub or a switch of the automation unit 2 and the web server 1, while other protocols are used between the hub or the switch and the component (e.g., Profibus® or Foundation Fieldbus ® etc.).

In an exemplary embodiment of the disclosure, the method for the automated control of the launch of the automation unit 2 can comprise the following procedural steps that are shown in FIG. 3. After the LAUNCH of the method, digital copies for all or selected components K are generated in step 100. The digital copies are data sets that comprise functionality data sets of the components K.

In step 200, interconnection rules are imported or provided. Those serve to determine the interconnectability of the individual respective components K.

In step 300, technical application data are imported.

In step 400, an application of the imported application data and the functionality data sets takes place according to the interconnection rules. In the process, a circuit diagram for the components K is generated. This circuit diagram indicates which components K are to be interconnected in which way and with which other component.

In step 500, the circuit diagram can be converted into control commands. The control commands in this exemplary embodiment of the disclosure serve to design, implement, and/or operate the automation unit 2. Afterwards, the method can end.

As indicated in FIG. 3, the method can be branched back to step 300 after step 400 to possibly import other application data. Thus, it is possible to implement and execute another application even during the operation of the automation unit 2. Similarly, step 100 can be carried out again to generate an updated digital copy in the case of an exchange of a component K with a replacement component.

By providing the component K to the logical chain of effects which are generated from their interconnection, it is advantageously possible for different entities to access so-called object dependencies, thus information between the individual components at a central place, namely the webserver 1. Accordingly, it becomes possible that the component manufacturer A, the unit manufacturer B, and the unit operator C access the webserver 1 to import the object dependency and process it.

A typical chain of effects can consist of control, communication, engine control, valve cluster or valve terminal, motor, actuator, and accessories. The composition of a chain of effects is domain-specific and can be adjusted.

The solution proposed according to the disclosure offers the possibility of a central control of the automation unit 2 with its components K throughout the entire life span of the automation unit 2. The life cycle of a unit 2 includes the phases of establishing contact with suppliers, designing, constructing, obtaining, assembling, launching, operating, updating, and recycling. With the system according to the disclosure, services can be provided that are based on component- and unit-specific engineering data, update information, data exchange with design and configuration software, data exchange with e-commerce-systems, collection, analysis, and processing of field data. With the object dependency between the components K, a unit-specific documentation can be generated. The patency of the system in connection with design-, configuration-, simulation-, and commerce systems enables a customer specific pre-parametrization of components K and further elements or systems as well as the providing and processing of a digital copy of components K, chain of effects, and units 2. A role- and right-management allows a collaboration of the different persons involved in the life cycle of a unit 2. Throughout the life cycle, persons of different component manufacturers, unit manufacturers, and unit operators are involved. Furthermore, favorites and best-practice solutions for chain of effects and units 2 can be generated and administered user-specifically, and used and adapted efficiently for new projects. The disclosure enables the collection of live-data of the components K as well. This can also include the analysis of live-data, historically stored data (e.g., in the form of log files) and data from further sources. For the analysis of those data, information can be used that are taken from the object dependency between the components K, the production configuration of the component K, and the preset parameters of the component K.

Current software systems known in the related art provide documentations that are not applicable to the present disclosure due to the non-existent object dependency between the components K. This disadvantageously leads to unnecessarily stored data volumes that additionally impede the user in their work because the user has to first select the relevant information, which is time consuming. According to the disclosure, it can be analyzed from the collected and provided object dependency whether the data set incurs at all for the currently executed version of the automation unit 2 and has to be considered or if it can otherwise be disregarded. According to the disclosure, the analysis occurs on the basis of a chain of effects in which the respective component K is interconnected. This information cannot be provided in the related art systems which thus support life cycle management functions for a unit 2 only conditionally. The system according to the disclosure makes it possible to obtain the right information at the right time from different view points on a unit 2 throughout the entire unit life cycle.

In a further exemplary embodiment of the disclosure, the system is linked to an electronic e-commerce system. It is possible to automatically transfer result data, especially control data, to a shopping basket.

Furthermore, the system can also be used for replacement orders with a transfer of the parameters that have been determined in the system, so that a spare part is immediately and correctly parametrized and can be delivered with customer- and/or unit-specific information.

Generally, it is possible to determine pre-configurations in the supply chain. This can occur automatically with reference to the unit parameters by generating and displaying a proposal to the user, which they only have to confirm with a confirmation signal.

It is possible to connect components K to a chain of effects/control. This can occur on a logical level. This way, an efficient allocation of components K to chain of effects can take place. The chain of effects can be built by simple user gestures on a user interface (drag-and-drop) and are thus far more efficient than conventional engineering-systems without object dependency.

The generated result data or control data can be transferred to a configuration and/or launch software. Similarly, customer inputs and other data from design- or simulation tools can be adopted and transferred automatically on an electronic basis.

It is also possible to provide a central role-/right-management for the collaboration of components K that are built into a unit 2 and are interconnected specifically throughout the life cycle of the same.

It is advantageously also possible to centrally administer the components K of different component manufacturers (meaning also foreign manufacturers) for all component manufacturers involved, for the unit manufacturer, and the unit operator and to also provide different access authorizations for the involved user roles. A component manufacturer delivers target-oriented specific and for the respective application of the automation unit 2 relevant documentation via the system. Furthermore, updates can be imported, and the component manufacturer obtains information on the chain of effects in which its components K are used.

Concludingly, it may be pointed out that the description of the disclosure and the embodiments are generally to be seen as nonrestrictive in regards to a certain physical realization of the disclosure. All features described and shown in connection with the individual embodiments of the disclosure can be intended in different combination in the object according to the disclosure to realize their advantageous effect at the same time. It is thus apparent, as well within the scope of the disclosure, to use the central control by means of a web server not only for a automation unit 2, but also for other production and manufacturing units or machines or devices that are built from electronic, interconnected modules or components. The database connected to the web server can be a relational database, an object-based database system, or a semi-structured database. It is readily apparent to a person skilled in the art that the disclosure cannot only be used in the area of fluid technology and pneumatic, but also for other electronic components that are built as a machine and whose interaction or functional dependencies are to be inspected.

Furthermore, the elements of the system and the web server can also be realized being distributed across several physical products. It is also possible to install the web server and the database on physically different systems.

The scope of protection of the present disclosure is given by the claims and is not restricted by the features described in the description or shown in the figures.

The foregoing description of the exemplary embodiments of the disclosure illustrates and describes the present disclosure. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### REFERENCE SIGNS

1 Web server
2 Automation unit
DB Database
A component manufacturer
B unit operator
C unit manufacturer
K component
ZD state date
SD control data
100 providing a digital copy of a component
200 providing interconnection rules
300 importing technical application data
400 Application
500 Generating a circuit diagram
600 Converting the circuit diagram to control commands
IN Input interface
OUT Output interface
P Processor
U Converting unit
MEM memory

1. A system for an automated design of an automation unit, the system comprising:
a plurality of electronically controllable components interconnected in a work dependency;
a central web server having a database configured to provide:
a digital copy with a functionality data set for each component from among the plurality of components, and
interconnection rules for interconnecting the plurality of components;
an interface configured to import technical application data for the automation unit;
a processor configured to apply the technical application data and the provided functionality data sets of the plurality of components based on the interconnection rules to generate a circuit diagram for the plurality of components; and
a converting unit configured to convert the generated circuit diagram to control commands for the design of the automation unit.

2. The system according to claim 1, wherein the system is configured to operate the automation unit.

3. The system according to claim 2, wherein the at least one component from among the plurality of components is provided with an output interface to collect state data of the respective at least one component during an operation of the automation unit and forward the state data to the central web server.

4. The system according to claim 3, wherein, in the case of a component error, a replacement component is requested automatically from the state data, which can be built into the automation unit according to the generated circuit diagram.

5. The system according to claim 1, wherein the collected state data are updated in a pre-defined time interval or event-based.

6. The system according to claim 1, wherein the collected state data are collected throughout an entire life span of at least one of the respective component or the automation unit.

7. The system according to claim 1, wherein the functionality data set represents all functional dependencies between the plurality of components.

8. The system according to claim 1, wherein metadata is provided in the database for the at least one component.

9. The system according to claim 1, wherein the at least one component is configured with an input interface to receive control data for operating the plurality of components in the automation unit.

10. The system according to claim 1, wherein the system is configured as a client-server system and further comprises an authenticatable network access from different entities with a specific user interface.

11. The system according to claim 1, wherein the application data are imported from a simulation tool or a computer-aided design (CAD) model.

12. The system according to claim 1, wherein at least one of the digital copy, the interconnection rules, the application data, the functionality data sets, the state data, or the circuit diagram is stored centrally accessible on a memory.

13. A method for an automated design of an automation unit, wherein a plurality of electronically controllable components is interconnected in a work dependency, the method comprising:
providing a digital copy with a functionality data set for each of the components on a central web server;
providing interconnection rules for interconnecting the plurality of components;
importing technical application data for the automation unit;
applying the technical application data and the respective functionality data sets of the plurality of components according to the interconnection rules with a processor to generate a circuit diagram for the plurality of components, and
converting the generated circuit diagram to control commands for the design of the automation unit.

14. The method according to claim 13, wherein the method is performed during operating of the automation unit to control the automation unit, and wherein state data are collected for the at least one component and are accessible in a central web server.

15. The method according to claim 13, wherein the plurality of components receive control data in their built-in state during the operation of the automation unit, and wherein the control data activate the respective component in a modified way.
